(19) United States
(12) Patent Application Publication
(10) Pub. No.: US 2005/0049348 A1
(43) Pub. Date: Mar. 3, 2005

(54) Electrical insulation tape, film backing thereof, and method of manufacturing the film backing

(76) Inventors: Lucky Lee, Hsinchu (TW); Ching-Chih Lai, Hsinchu (TW); Jia-Ming Lin, Hsinchu (TW); Yu-Chin Lin, Natou (TW)

Correspondence Address: BIRCH STEWART KOLASCH & BIRCH, PO BOX 747, FALLS CHURCH, VA, 22040-0747, US

(21) Appl. No.: 10/732,515

(22) Filed: Dec. 11, 2003

(30) Foreign Application Priority Data
Aug. 27, 2003 (TW) 092123541

(51) Int. Cl. C08K 5/02

(52) U.S. Cl. 524/464

(57) ABSTRACT

An electrical insulation tape, film backing thereof, and method of manufacturing the film backing. The film backing comprises about 20 to 80 parts by weight of polyethylene, about 80 to 20 parts by weight of EPDM rubber, about 0 to 30 parts by weight of fillers, 0 to 50 parts by weight of flame retardant, and about 0 to 20 parts by weight of processing aids. The film backing has physical properties similar to PVC film backings, and thus can replace the PVC film backing used in the electrical insulation tape.

### BACKGROUND OF THE INVENTION

1. Field of the Invention

The present invention relates to an electrical insulation tape, a film backing thereof, and a method of manufacturing the film backing.

2. Description of the Related Art

Electrical insulation tape is commonly made with polyvinyl chloride (PVC) film backing due to its low cost, good processability, heat resistance, and flame retardant properties. The amount produced and its uses are enormous. In the last decade, however, environmentally friendly, or eco-materials, have been extensively developed to protect the environment. The European Union has even proposed banning lead and halogen in electronics by 2004. Therefore, an environmentally friendly material is urgently needed to replace PVC film backing in electrical insulation tape.

Film backing materials of electrical insulation tape have already been developed to replace PVC, but the materials contain crosslinking agents for reinforcement to emulate the physical characteristics of PVC tape. This, however, is disadvantageous to recycling and reuse.

For example, U.S. Pat. No. 5,284,889 discloses an electrical insulating film comprising 60 to 100 parts of an ethylene vinyl acetate copolymer (EVA), 0 to 40 parts of ethylene propylene diene rubber (EPDM rubber), 0.05 to 5 parts of a silane coupling agent, 5 to 25 parts of a bromine containing flame retardant, 1.5 to 10 parts of an antimony containing flame retardant, and 1 to 20 parts of metal oxide hydrates. The stress-strain curves of examples are shown in FIG. 1. The film mainly contains EVA and a small portion of EPDM and is reinforced by crosslinking and is therefore difficult to recycle and reuse.

U.S. Pat. No. 5,498,476 discloses an electrical insulating film comprising 60 to 100 parts of EVA, 0 to 40 parts of EPDM, 0.05 to 5 parts of an amino-functional silane coupling agent, and 40 to 150 parts of ethylene diamine phosphate flame retardant. The film mainly contains EVA and a small portion of EPDM and is reinforced by crosslinking and is therefore difficult to recycle and reuse.

U.S. Pat. No. 6,376,068 discloses an insulation protection film comprising polyolefins, EPDM, flame retardants, and further comprising plasticizers, dyes, pigments, antioxidants, or antistatic agents for use in the protection of steel pipes.

Hence, there is still a need for a better film backing for use in electrical insulation tape.

### SUMMARY OF THE INVENTION

Accordingly, an object of the invention is to provide an electrical insulation tape film backing having similar physical properties and physical characteristics upon working to conventional PVC film backings as well as may be halogen-free and recyclable.

Another object of the invention is to provide an electrical insulation tape comprising the film backing as described above.

Still another object of the invention is to provide a method of manufacturing an electrical insulation tape film backing. The film backing obtained by this unique method has physical characteristics similar to conventional PVC film backings and may be halogen-free and recyclable.

The electrical insulation tape film backing of the present invention comprises 20 to 80 parts of polyethylene, 80 to 20 parts of EPDM rubber, 0 to 30 parts of fillers, 0 to 50 parts of flame retardant, and 0 to 20 parts of processing aids.

All “parts” herein are by weight unless specifically noted otherwise.

The electrical insulation tape of the present invention comprises the film backing as defined above and an adhesive coated on one surface of the film backing.

The method of manufacturing an electrical insulation tape film backing comprises the steps of providing a mixture of polyethylene and EPDM rubber, forming a film from the mixture by melting the mixture at 100 to 240° C., drawing the film at a stretch ratio of from 1:1 to 1:10 in two perpendicular directions, and performing a surface treatment on the film.

The present invention employs eco-materials to manufacture film backing suitable for electrical insulation tape, but is easier to recycle and reuse than the film backing of the prior art.

### BRIEF DESCRIPTION OF THE DRAWINGS

The present invention can be more fully understood by reading the subsequent detailed description and examples with references made to the accompanying drawings, wherein:

FIG. 1 shows the stress-strain curves of the film backing of the related art; and

FIG. 2 shows the stress-strain curves of the electrical insulation tape film backing of the present invention, a conventional PVC film backing, and a film backing of the comparative example, respectively.

### DETAILED DESCRIPTION OF THE INVENTION

The electrical insulation tape film backing of the present invention comprises about 20 to 80 parts, and preferably about 30 to 70 parts of polyethylene (PE). The molecular weight of polyethylene ranges from about 50,000 to 300,000, and preferably from about 100,000 to 200,000.

The electrical insulation tape film backing of the present invention comprises about 80 to 20 parts, and preferably about 70 to 30 parts of EPDM rubber. The EPDM rubber may contain about 50 to 95 parts of ethylene, about 5 to 50 parts of propylene, and about 0 to 3 parts of diene.

The electrical insulation tape film backing of the present invention may comprise about 0 to 30 parts, and preferably about 1 to 20 parts of fillers, such as silicon dioxide, titanium dioxide, calcium carbonate, magnesium carbonate, calcium sulfate, barium sulfate, aluminum silicate, and the like. The film backing may or may not contain fillers, as long as said fillers do not affect the desired physical properties of the film backing.

The electrical insulation tape film backing of the present invention may comprise 0 to 50 parts, and preferably about 1 to 20 parts of flame retardant, such as, but not limited to, phosphorous compounds, inorganic salts, halogenated compounds. The film backing may or may not contain flame retardant, as long as said flame retardant do not affect the desired physical properties of the film backing.

The electrical insulation tape film backing of the present invention may comprise about 0 to 20 parts, and preferably about 0.5 to 15 parts of processing aids, such as release agents, coupling agents, lubricants, and the like. The type and amount of the processing aids depend on the manufacturing process for the film backing. The film backing may or may not contain processing aids as long as said processing aids do not affect the desired physical properties of the film backing.

The electrical insulation tape film backing of the present invention may further comprise, for example, pigments, dyes, UV stabilizers, plasticizers, fungicides, waxes, antioxidants, and the like, in amounts known to those skilled in the art.

The thickness of the electrical insulation tape film backing of the present invention is about 0.02 to 0.30 mm, and preferably about 0.08 to 0.20 mm. The tensile strength is between 1.3 and 3.0 kgf/mm². The elongation at break is between 100% and 700%. The breakdown voltage is between 39 and 150 kv/mm. The deformation set is between 5% and 20%. These physical properties are similar to those of conventional PVC film backing and the breakdown voltage properties are superior. Furthermore, the analysis of stress-strain curves as the film backing stretches and recovers indicates that the physical characteristics of the film backing of the present invention are similar to that of a conventional PVC film backing, that is, the film backing of the present invention exhibits qualities similar to the conventional backing, such as resilience, tenacity, texture, and tight contraction and envelopment after stretching. These qualities, referred to herein as “physical characteristics”, are similar to those of the conventional PVC tape. Therefore, the electrical insulation tape of the present invention is capable of completely replacing PVC tape and recyclable.

The method of manufacturing an electrical insulation tape film backing is described as follows.

First, a mixture of polyethylene and EPDM rubber, and optional fillers, flame retardant, processing aids, or additives, as described above is provided. The mixture is mixed using a mixer or extruder. The condition for mixing is not specially limited. Generally, the result is better when the mixing speed is higher.

After mixing, the mixture may be made into pellets through a twin screw extruder at about 100 to 240° C. for the convenience of the mechanical operation.

Next, the mixture or pellets are melted and formed into a film at 100 to 240° C., and preferably 140 to 180° C. The film may be formed by blown film molding, single screw extrusion molding, twin screw extrusion molding, or calendaring. The film thickness is about 0.02 to 0.30 mm.

Next, the film is drawn at a stretch ratio of from 1:1 to 1:10, and preferably 1:1 to 1:5 in the longitudinal or machine direction (MD) and at a stretch ratio from 1:1 to 1:10, and preferably 1:1 to 1:5 in the transverse or crosswise direction (CD). This is a critical and novel step of the method of the present invention. In this step the electrical insulation tape film backing obtains physical properties similar to those of PVC film backings.

Finally, the film obtained is subjected a surface treatment to form the film of the present invention. The surface treatment can improve the adhesion of the film surface to the adhesive to form tapes. The method of surface treatment is not specially limited and can be one known to those skilled in the art, for example, corona treatment (for example, 1000 to 5000 volt/cm²), chemical treatment (for example, coating a primer), and the like. The resulting film has a thickness of about 0.02 to 0.30 mm, and preferably 0.08 to 0.20 mm.

The film backing subjected to a surface treatment is uniformly coated with a layer of polymeric pressure sensitive adhesive, such as acrylic adhesive and rubber adhesive, with an adhesive force of 1.4 to 5.8 kgf/19 mm, with a thickness of 0.01 to 0.05 mm, forming an electrical insulation tape.

Therefore, the electrical insulation tape can replace PVC tape completely.

### EXAMPLES

### Example 1

100 parts by weight of PE (C7100 produced by Asia Polymer corporation, Taiwan), 118 parts by weight of EPDM rubber (DuPont Nordel 1070), and 4.4 parts by weight of a release agent were placed in a mixer and mixed at a high speed, and then pelletized by a twin screw extruder at 190° C. The resulting pellets were placed in a single screw extruder with a screw of 90 mm in diameter, the ratio of the length to the diameter (L/D) of the screw: 30, and a die of 400 mm in diameter at 140 to 180° C. to undergo extrusion and blow molding to form a film. The film thickness at the die orifice opening was 1.8 mm. Then, the film was drawn at a stretch ratio of 1:3 in the longitudinal direction and at a stretch ratio of 1:4 in the transverse direction, giving a film of 0.15 mm in thickness. Then, the film was subjected to a corona treatment with 2000 voltage/cm², giving an electrical insulation tape film backing product of the present invention.

### Comparative Example 1

A film backing was obtained using the same method as used in the Example 1, provided that unmodified PE (C7100 produced by Asia Polymer Corporation, Taiwan) was used instead of PE and EPDM rubber.

Test 1

The tensile strength, elongation at break, breakdown voltage, and deformation set of a conventional PVC electrical insulation tape film backing, the unmodified PE film backing of the Comparative Example 1, and the electrical insulation tape film backing of the present invention obtained from the Example 1 were tested, respectively, according to UL-510 test standard. The result is as shown in Table 1.

AS shown in Table 1, the unmodified PE film backing had poor physical properties and the deformation set was 27 to 32%. The electrical insulation tape film backing of the Example 1 possessed improved physical properties and enhanced breakdown voltage. Furthermore, the stress-strain curve measured as stretching superposed that of the PVC film backing, indicating the same physical properties as those of the PVC film backing.

TABLE 1

| | Tensile | | Breakdown | |
|---|---|---|---|---|
| | strength, | Elongation | voltage, | Deformation |
| Sample | kgf/mm² | at break, % | kV/mm | set, % |
| UL-510 | PVC 1.41 | PVC 100 | 39 | NA |
| qualified | PE 1.05 | PE 60 | | |
| standard | | | | |
| PVC | 2.3 | 268 | 79 | 11-14 |
| Comparative | 1.5 | 458 | 99 | 27-32 |
| Example 1 | | | | |
| Example 1 | 1.39 | 593 | 133 | 14-18 |

NA: not applicable

Test 1-1

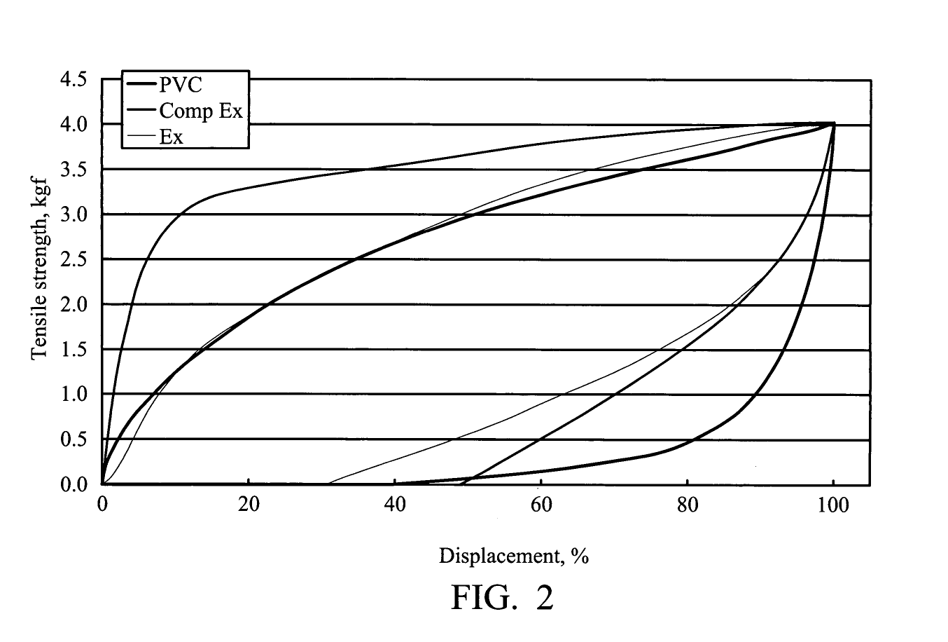

The stress-strain properties of a conventional PVC electrical insulation tape film backing, the unmodified PE film backing of the Comparative Example 1, and the electrical insulation tape film backing of the present invention obtained from the Example 1 were tested, respectively, with a stretching speed of 200 mm/min, according to UL-510 test standard, and the stress-strain curves are as shown in FIG. 2. As shown in FIG. 2, when the electrical insulation tape film backing of the present invention was stretched, it had a tensile strength similar to that of the conventional PVC film backing. The tensile strength was continuously measured during the recovery of the film backing from the deformation. The curve also demonstrated characteristics similar to that of the PVC film backing. The data indicated that when the electrical insulation tape of the present invention was manipulated, it exhibited physical characteristics on drawing, tear, and envelopment similar to those of conventional PVC tapes. This is one of the features of the present invention.

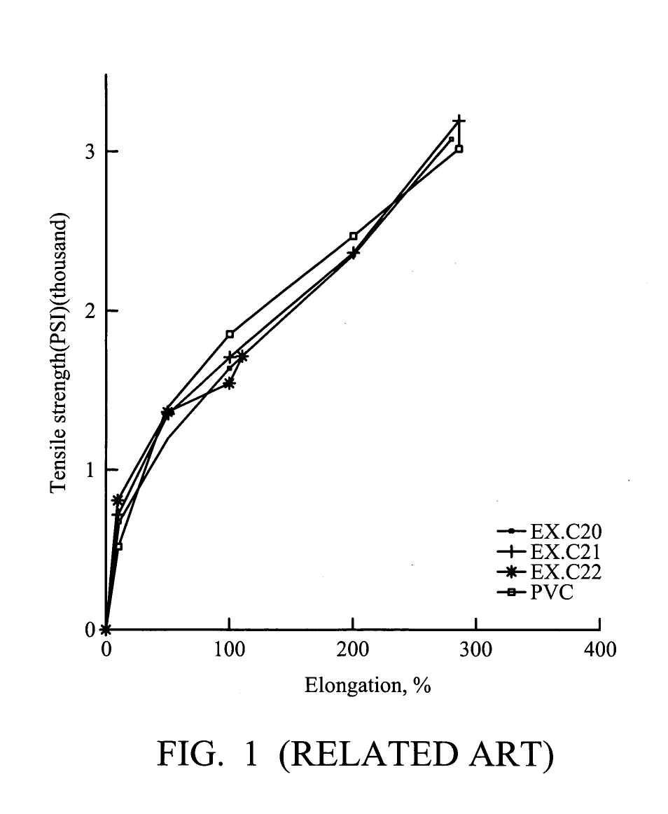

Referring to FIG. 1, excerpted from the specification of U.S. Pat. No. 5,284,889 (which is incorporated herein for reference), it shows stress-strain curves of three examples with compositions of EVA2/EPDM2: 75/25 (no fillers), EVA2/EPDM2: 85/25 (no fillers), and EVA2/EPDM2/ATH1/Br1/Sb1/Mb1: 59/15/11/74/4 (26% by weight of fillers), respectively. The analysis focuses solely on the curve depicting the stretching of the tape, and the physical properties (for example, tensile strength) during the recovery of the tape is not disclosed or suggested. However, in the present invention, by analyzing the variation of the curve depicting both of the stretching and the recovery of the tape, the differences of non-PVC film backing and PVC film backing are proven, therefore, an electrical insulation tape film backing with improved properties can be achieved.

### Comparative Example 2

A film backing was obtained using the same method as used in the Example 1, provided that 75 parts of EVA (Du Pont Elavax 470) and 25 parts of EPDM (Du Pont Nordel 1070), as referred to in U.S. Pat. No. 5,284,889, were used instead of PE and EPDM rubber.

Test 2

The tensile strength, elongation at break, deformation set and heating shrinkage of a conventional PVC electrical insulation tape film backing, the EVA/EPDM film backing of the Comparative Example 2, and the electrical insulation tape film backing of the present invention obtained from the Example 1 were tested, respectively, according to UL-510 test standard. The result is as shown in Table 2.

As shown in Table 2, the EVA/EPDM film backing had heating shrinkage as high as —58.48% (MD) while the other physical properties were good. The heating shrinkage of —58.48% was a serious problem in drying of pressure sensitive adhesive coating process during commercial manufacture of electrical insulation tape. The heating shrinkage of +10% is experience rating.

TABLE 2

| | Tensile | | | Heating | |
|---|---|---|---|---|---|
| | strength, | Elongation | Deformation | Shrinkage, % | |
| Sample | kgf/mm² | at break, % | set, % | CD | MD |
| UL-510 | PVC 1.41 | PVC 100 | NA | NA | |
| qualified | PE 1.05 | PE 60 | | | |
| standard | | | | | |
| PVC | 2.3 | 268 | 11-14 | 0.84 | −3.44 |
| Comparative | 1.8 | 374 | 10-11 | −8.45 | −58.48 |
| Example 2 | | | | | |
| Example 1 | 1.39 | 593 | 14-18 | 1.20 | −4.91 |

NA: not applicable

### Examples 2 and 3

A film backing was obtained using the same method as used in the Example 1, provided that 20 parts of halogen flame retardant (Constab FR7023LD) or 20 parts of halogen-free flame retardant (Constab FR7082LD) was used in electrical insulation tape film backing of the present invention as Examples 2 and 3, respectively.

Test 2

The tensile strength, elongation at break, deformation set, flame test and adhesive strength of a conventional PVC electrical insulation tape film backing, the electrical insulation tape film backing of the present invention containing halogen flame retardant (Example 2), halogen-free flame retardant (Example 3), and the electrical insulation tape film backing of the present invention obtained from the Example 1 were tested, respectively, according to UL-510 test standard. The result is as shown in Table 3.

As shown in Table 3, the electrical insulation tape film backing of the present invention containing halogen flame retardant (Example 2) or halogen-free flame retardant (Example 3) had the qualified flame test result as the conventional PVC electrical insulation tape film backing while the other physical properties were good. All the film backing had adhesive strength more than 18 gf/mm, the qualified data, after coating with acrylic pressure sensitive adhesive.

TABLE 3

| | | | | Adhesive | | |
|---|---|---|---|---|---|---|
| | | | | Strength, | Heating | |
| | Tensile | Elongation | | gf/mm, | Shrinkage, | |
| | strength, | at | Flame | Peel | % | |
| Sample | kgf/mm² | break, % | Test | 180° | CD | MD |
| UL-510 | PVC 1.41 | PVC 100 | Flame | 18.0 | NA | |
| qualified | PE 1.05 | PE 60 | ceased | | | |
| standard | | | within 15 | | | |
| | | | seconds | | | |
| PVC | 2.3 | 268 | qualified | 28.5 | 0.84 | −3.44 |
| Example 2 | 1.18 | 564 | qualified | 26.0 | 1.06 | −6.40 |
| Example 3 | 1.19 | 566 | qualified | 26.7 | 1.28 | −5.48 |
| Example 1 | 1.39 | 593 | un- | 30.5 | 1.20 | −4.91 |
| | | | qualified | | | |

NA: not applicable

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An electrical insulation tape film backing, comprising:
to 80 parts by weight of polyethylene,
80 to 20 parts by weight of EPDM rubber,
0 to 30 parts by weight of fillers,
0 to 50 parts by weight of flame retardant, and
0 to 20 parts by weight of processing aids.

2. The film backing as claimed in claim 1, wherein the film backing has a tensile strength of 1.3 to 3.0 kgf/mm².

3. The film backing as claimed in claim 1, wherein the film backing has an elongation at break of 100% to 700%.

4. The film backing as claimed in claim 1, wherein the film backing has a breakdown voltage of 39 to 150 kv/mm.

5. The film backing as claimed in claim 1, wherein the film backing has a recovery from deformation of 5 to 20%.

6. The film backing as claimed in claim 1, wherein the film backing has a thickness of 0.02 to 0.30 mm.

7. An electrical insulation tape, comprising:
a film backing comprising 20 to 80 parts by weight of polyethylene, 80 to 20 parts by weight of EPDM rubber, 0 to 30 parts by weight of fillers, 0 to 50 parts by weight of flame retardant, and 0 to 20 parts by weight of processing aids; and
an adhesive coated on one surface of the film backing.

8. The electrical insulation tape as claimed in claim 7, wherein the film backing has a tensile strength of 1.3 to 3.0 kgf/mm².

9. The electrical insulation tape as claimed in claim 7, wherein the film backing has an elongation at break of 100% to 700%.

10. The electrical insulation tape as claimed in claim 7, wherein the film backing has a breakdown voltage of 39 to 150 kv/mm.

11. The electrical insulation tape as claimed in claim 7, wherein the film backing has a recovery from deformation of 5 to 20%.

12. The electrical insulation tape as claimed in claim 7, wherein the film backing has a thickness of 0.02 to 0.30 mm.

13. A method of manufacturing an electrical insulation tape film backing, comprising the steps of:
(i) providing a mixture of polyethylene and EPDM rubber;
(ii) forming a film from the mixture by melting the mixture at 100 to 240° C.;
(iii) drawing the film at a stretch ratio of from 1:1 to 1:10 in two perpendicular directions; and
(iv) performing a surface treatment on the film obtained from the step (iii).

14. The method as claimed in claim 13, wherein, the mixture of the step (i) contains 20 to 80 parts by weight of polyethylene and 80 to 20 parts by weight of EPDM rubber.

15. The method as claimed in claim 14, wherein the mixture further contains fillers.

16. The method as claimed in claim 14, wherein the mixture further contains flame retardants.

17. The method as claimed in claim 14, wherein the mixture further contains processing aids.

18. The method as claimed in claim 14, wherein the mixture further contains colorants.

19. The method as claimed in claim 13, wherein, in the step (ii), a film is formed from the mixture by melting the mixture at 140 to 180° C.

20. The method as claimed in claim 13, wherein, in the step (ii), a film is formed by blow molding, single screw extrusion molding, twin screw extrusion molding, or calendaring.

21. The method as claimed in claim 20, wherein, in the step (ii), forming a film is performed by single screw extrusion molding with a screw of 90 mm in diameter and the ratio of the length to the diameter of the screw is 30.

22. The method as claimed in claim 13, wherein the surface treatment is corona treatment or chemical treatment.

23. The method as claimed in claim 13, wherein, after the step (i) and before the step (ii), further comprising the step of:
pelletizing the mixture.
